(19) United States
(12) Patent Application Publication
(10) Pub. No.: US 2008/0116315 A1
(43) Pub. Date: May 22, 2008

(54) Soaring wind turbine

(76) Inventor: Ron Wayne Hamburg, Sacramento, CA (US)

Correspondence Address: RON WAYNE HAMBURG, 5518 DATE AVENUE, SACRAMENTO, CA, 95842, US

(21) Appl. No.: 11/602,663

(22) Filed: Nov. 21, 2006

(51) Int. Cl. B64B 1/06

(52) U.S. Cl. 244/30

(57) ABSTRACT

The Soaring Wind Turbine is an alternative in electrical power production for all sizes of wind turbines. The wind turbine is lifted by two (2) lighter-than-air craft known as dirigibles. These dirigibles contain helium and can climb to one-thousand (1000) feet above ground level. With the capability to increase altitude the best winds can be found at any geographical location. The wind turbine stays aloft generating continuous power and through a tether cable it can be pulled downward in a storm or let out to acquire faster wind speeds above. Lighter-than-air craft carrying wind turbines to altitudes where wind speeds offer full-time electrical power production, can solve temporary or permanent power needs any where in the world.

### CROSS-REFERENCE TO RELATED APPLICATIONS

“Not Applicable”

### STATEMENT REGARDING FEDERALLY SPONSORED RESEARCH

“Not Applicable”

### REFERENCE TO SEQUENCE LISTING

“Not Applicable”

### BACKGROUND OF THE INVENTION

The Soaring Wind Turbine is related to electricity producing wind turbine generators used on ships at sea and on structures in remote areas where there is no electricity available. This wind turbine is launched and lifted to altitudes from one-hundred (100) feet to one-thousand (1000) feet by two (2) lighter-than-air craft dirigibles.

With consideration to the research in wind speed measurement, it has been determined that wind speed increases with altitude in all areas of the world. This wind turbine is capable of ascending and finding the faster winds at the higher altitude. This assures continuous electricity production unlike a similiar tower mounted wind turbine generator. The Soaring Wind Turbine with a forty-four (44) foot rotor diameter and twelve (12) kilo-watt generator could produce eight-thousand, six-hundred and forty (8,640) kilo-watt-hours per month in ninety-nine (99%) per cent of the world, with only a seven (7) miles per hour wind speed.

### SUMMARY OF THE INVENTION

In summary the Soaring Wind Turbine was developed after observing down-time in tower mounted wind turbines that are limited to wind speeds at tower height altitudes. These stationary wind turbines can be slowed or stopped during low wind speed periods, and continuous electricity production would be an advantage to this.

According to the U.S. Department of Energy wind maps, wind power resource estimates have been recorded and mapped for most states and also the entire country. Refering to this data, wind power classes have been color-coded on maps and correspond to wind speeds at the fifty (50) meter above ground level. By climbing another seventy (70) meters, above what is color-coded and mapped the wind power class can be increased to the next higher wind power class. For example, wind power class No. 3 (Fair) increased to wind power class No. 4 (Good) or No. 5 (Excellent) just by rising to the faster wind at the higher altitudes.

Due to ground friction (ie., buildings, hills, trees, etc.) the air near the ground usually has the slowest wind speed. The fifty (50) meter above ground level wind speeds will be slower than the wind speeds at two-hundred (200) meters, and the wind speed increase can make the difference in continuous power supply. Cut-in wind speeds (the wind speed at which the generator operates) for many wind turbines is about seven (7) miles per hour. This wind speed can be found between the ground and up to one-thousand (1000) feet altitude everywhere in the world with few exceptions. With a Soaring Wind Turbine electricity can be generated any where in the world also.

Lighter-than-air craft carrying wind turbines to altitudes where wind speeds offer full-time power production, can solve temporary or permanent power needs.

### BRIEF DESCRIPTION OF SEVERAL VIEWS OF THE DRAWINGS

Here in these drawings, the general layout of the Soaring Wind Turbine is depicted. The drawings show the isometric view of a double and single dirigible application. A description of the parts of this invention is as follows:

FIG. 1 is an isometric view of the double dirigible type Soaring Wind Turbine. The drawing shows: (1) the wind turbine rotor, (2) the enclosed gearbox and generator, (3) the helium filled dirigibles, (4) the exterior housing, (5) the vertical tail section, (6) the support platform, (7) the steel cable tether and electrical conductors.

FIG. 2 is an isometric view of a single dirigible Soaring Wind Turbine. The drawing shows: (1) the wind turbine rotor, (2) the enclosed gearbox and generator, (3) the helium filled dirigible, (4) the exterior housing, (5) the vertical tail section, (7) the steel cable tether and electrical conductors.

FIG. 3 is a plan view, the drawing shows: (1) the wind turbine rotor, (2) the enclosed gearbox and generator (3) the helium filled dirigibles, (4) the exterior housing, (5) the vertical tail section, (6) the support platform.

FIG. 4 is a front view, the drawing shows: (1) the wind turbine rotor (AKA; the swept area), (3) the helium filled dirigibles, (5) the vertical tail section, (6) the support platform, (7) the steel cable tether and electrical conductors.

FIG. 5 is a side view, the drawing shows: (1) the wind turbine rotor, (2) the enclosed gearbox and generator, (3) the helium filled dirigible(s), (4) the exterior housing, (5) the vertical tail section, (7) the steel cable tether and electrical conductors.

### DETAILED DESCRIPTION OF THE INVENTION

The Soaring Wind Turbine can be described as follows: Two (2) three-thousand (3000) cubic feet dirigibles, with a total volume of six-thousand (6000) cubic feet. An aluminum structural frame is welded together and covered with rubber-nylon fabric. The dirigibles are identical and measure eight (8) foot diameter and thirty-two (32) feet long. The-lighter-than-air helium within the dirigibles allows for it to climb to one-thousand feet altitude.

An aluminum framed platform is fastened to the dirigibles and the fiberglas rotor, electrical generator, aluminum housing, and aluminum and fiberglas vertical tail section is suspended between these two (2) dirigibles. A steel cable tether is attached to the aluminum platform to anchor the Soaring Wind Turbine to a ground station. Electrical power is conducted to ground station with electrical wiring wound along with steel cable tether.

The color-coded wind maps are used for a site-specific design, where the rotor diameter is determined using the wind power density (watts of power per square meter of the rotor swept area) at the location of operation and the dirigible volumes to stay aloft in a wind power class and wind speed that is good. This can vary from four-hundred (400) feet to one-thousand (1000) feet and the volume of helium required varies respectively.

Wind power classes can improve to the next higher wind power class every seventy (70) meters or two-hundred and thirty (230) feet of altitude. This wind turbine has the potential of producing electrical power anywhere in the world.

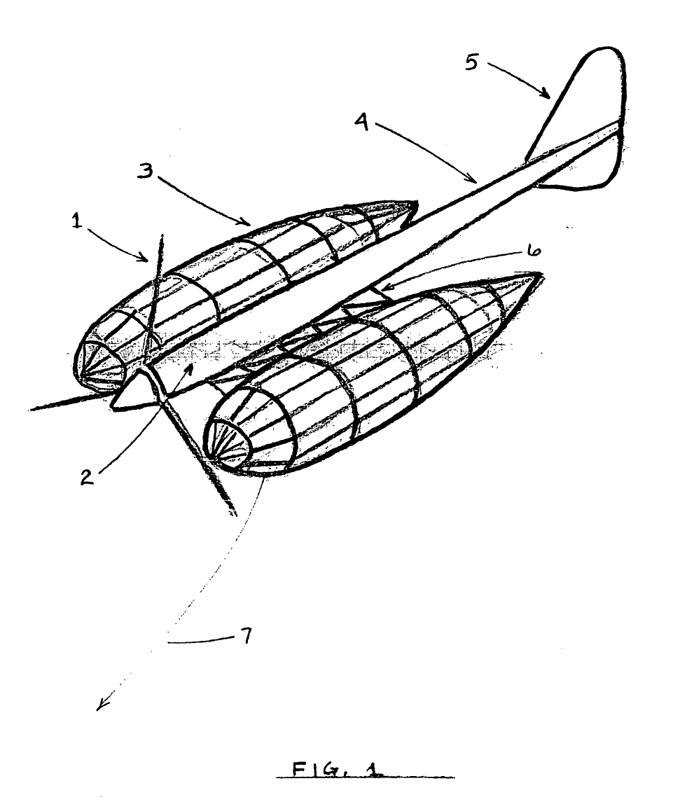

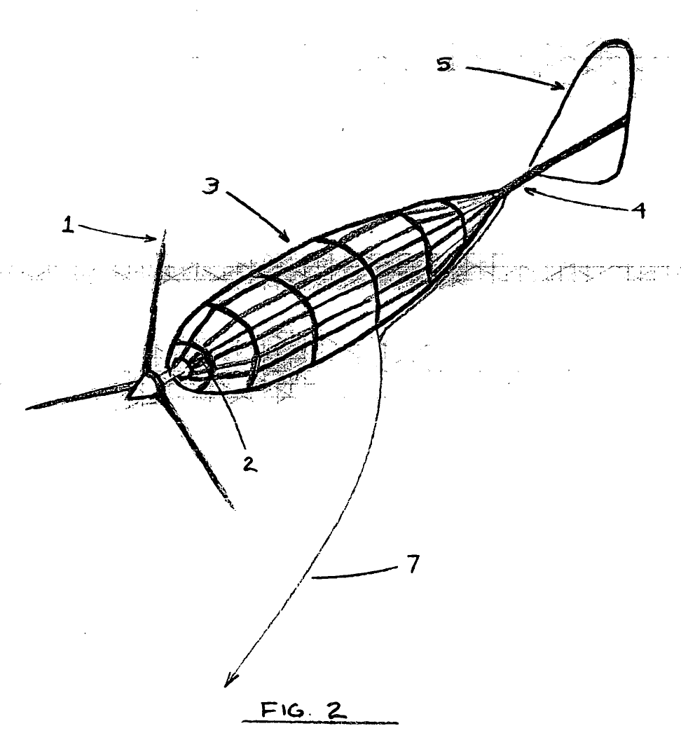

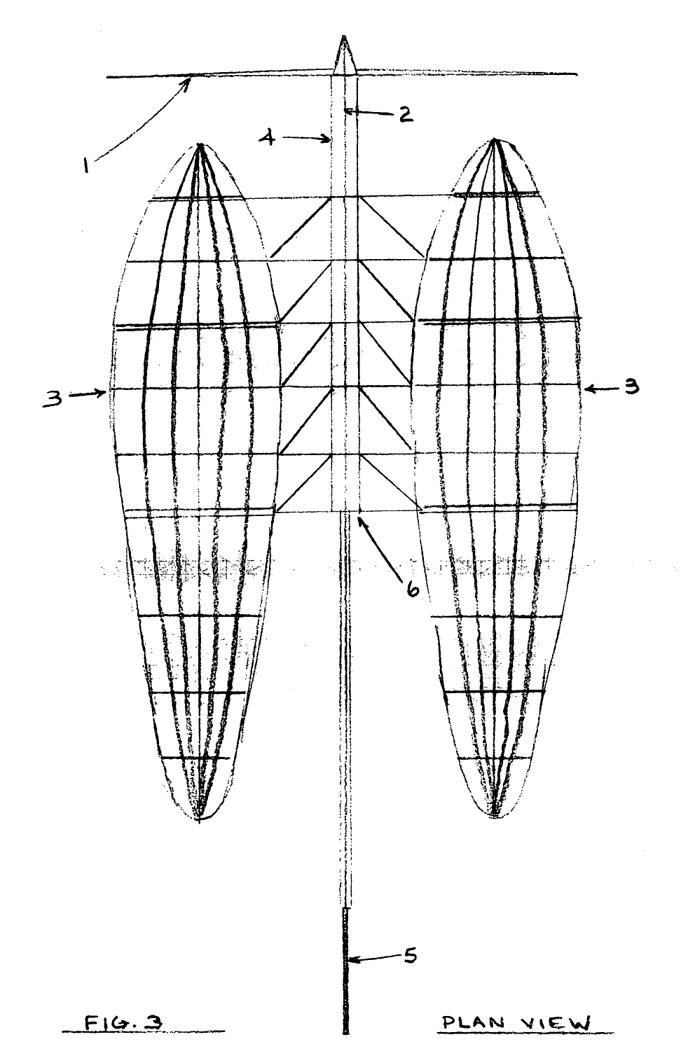

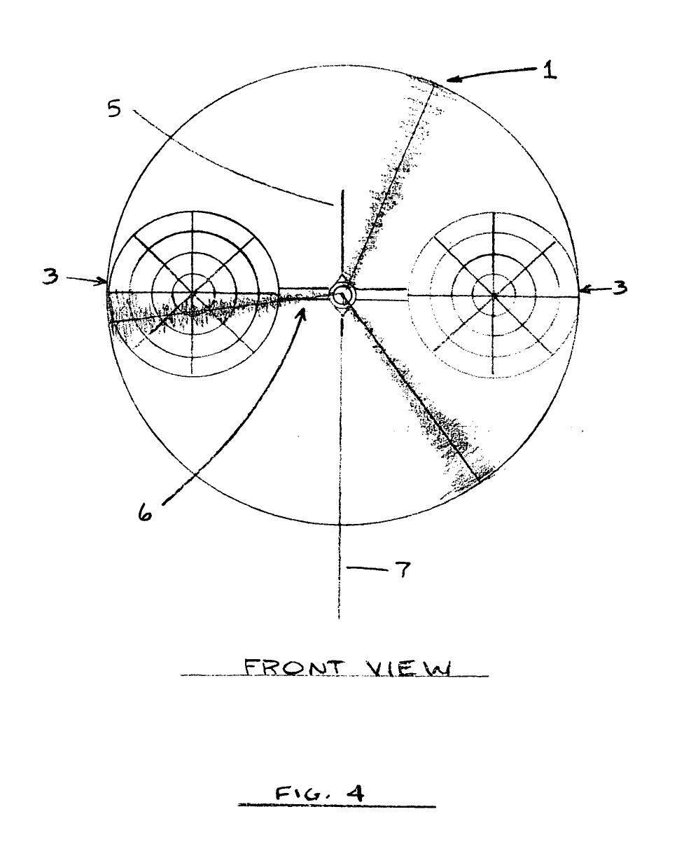

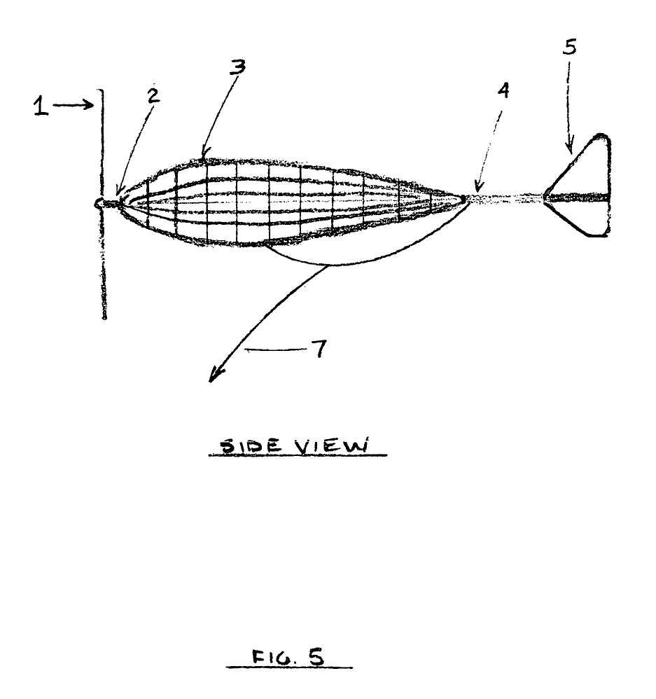

1. I claim all rights for the invention of the combination of one (1) or two (2) dirigibles, one (1) wind turbine, one (1) gearbox, the exterior housing, the vertical tail and connecting section, steel cable tether with electrical conductors, the platform that supports these components all shown in FIG. 1., FIG. 2, FIG. 3, FIG. 4, and FIG. 5, of the drawings.

2. I claim all rights for the invention of the process of producing electricity with the combination of components mentioned in claim No. 1 and shown in FIG. 1, FIG. 2, FIG. 3, FIG. 4 and FIG. 5 of the drawings, which encompasses one (1) or two (2) lighter-than-air dirigibles lifting a wind generator to varying altitudes and tethered to a ground station on land or sea.
